(19) United States
(12) Patent Application Publication
(10) Pub. No.: US 2013/0183401 A1
(43) Pub. Date: Jul. 18, 2013

(54) MICROWAVEABLE PET TREAT PAN AND METHOD OF PREPARING PET TREAT THEREWITH

(71) Applicant: LUCKY PAWS, LLC, Covington, KY (US)

(72) Inventor: Melinda Kirk, Ft. Mitchell, KY (US)

(73) Assignee: LUCKY PAWS, LLC, Covington, KY (US)

(21) Appl. No.: 13/787,329

(22) Filed: Mar. 6, 2013

Related U.S. Application Data
(62) Division of application No. 13/403,429, filed on Feb. 23, 2012.
Application No. 13/403,429 is a division of application No. 12/716,574, filed on Mar. 3, 2010, now abandoned.

(51) Int. Cl. A23K 1/00

(52) U.S. Cl. CPC A23K 1/003
USPC 426/2; 426/242

(57) ABSTRACT

A pan for microwave preparation of a pet treat for a type of pet comprising a plastic pan consisting essentially of microwavable plastic material and defining at least one pocket for receiving a pet treat mixture, the pocket defining a shape corresponding to the type of pet to be given the pet treat, such that the mixture can be conformed to the shape of, and microwaved in, the pocket to produce a pet treat at home.

### CROSS REFERENCE TO RELATED APPLICATION

This application is a divisional of my U.S. patent application Ser. No. 13/403,429, filed Feb. 23, 2012, which is a divisional of my U.S. patent application Ser. No. 12/716,574, filed Mar. 3, 2010, the disclosures of both of which are incorporated by reference herein in their entirety.

### FIELD OF THE INVENTION

The present invention relates to pet treats, and more particularly, to a microwaveable pan for preparing a pet treat and a method of use thereof.

### BACKGROUND OF THE INVENTION

Pet treats are typically pre-made and then bought through retail outlets to be given to pets at home. These pet treats are usually formed in a shape corresponding to the type of pet to be given the treat, such as a bone for a dog, or a fish for a cat, by way of example. But many prefer not to feed store-bought products to their pets. As a result, some have attempted to make their own pet treats at home. One proposal has been to create a mixture of pet treat material and bake it in a metal pan in the oven. The metal pan may have a pocket defining a shape corresponding to the type of pet to be given the treat, such as a bone shape for a dog pet treat. That has the advantage that the pet treat may be fresher and perhaps made of more wholesome materials than might be found in pre-made pet treats. But there are also drawbacks associated with making pet treats in this manner

Oven baking is recognized to require substantial amounts of energy, generates a lot of wasted heat, and takes quite a long time to complete a baking process. Further, a long period of time after the pet treat mixture has been baked is often necessary to allow the pet treat to cool sufficiently before it can be fed to the pet.

Accordingly, there is a need for a faster and more efficient way to make pet treats at home.

### SUMMARY OF THE INVENTION

The present invention provides a microwavable plastic pan by which to make a pet treat at home which is faster and more efficient than baking in a metal pan. Further, the present invention provides a method of using the microwavable plastic pan for quickly and efficiently making the pet treat. To that end, and in accordance with the principles of the present invention, a pan for microwave preparation of the pet treat is provided in which the pan consists essentially of microwaveable plastic material and defines at least one pocket for receiving the pet treat mixture wherein the pocket defines a shape corresponding to the type of pet to be given the pet treat. The pan may advantageously contain several such pockets. The pan may also include thickened edge portions that define handles to facilitate handling of the pan. The microwavable plastic pan facilitates making pet treats by placing a mixture of pet treat material in the pocket and then microwaving the pan with the mixture therein.

In accordance with a further aspect of the present invention, a pet treat is formed by microwaving a pet treat mixture which may be formed by mixing a dry pet treat base material which may advantageously be of organic material, water, and peanut butter. At least a portion of the mixture is placed into a pocket of a microwaveable plastic pan which is formed in a shape corresponding to the pet type. The pan may contain several such pockets, and a portion of the mixture may be placed into one or more of the pockets. The microwaveable plastic pan is then placed in the microwave, and microwaved to produce a pet treat (or pet treats if multiple pockets are used) that conforms to the shape. Thereafter, the pet treat is removed from the pan so as to be available to be given to the pet.

The microwaving process takes only a couple of minutes as contrasted to the long baking times involved with metal pans. Also, much less waste heat is generated, and the pet treat can be made at far less cost. Moreover, the resulting microwaved pet treat conforms to the shape of the pocket and is ready to be given to the pet after only a brief cool-down period as contrasted to the long cool-down periods often encountered with baked pet treats.

By virtue of the foregoing, there is thus provided a microwavable plastic pan by which to make a pet treat at home which is faster and more efficient than baking in a metal pan, and a method of using the microwavable plastic pan for quickly and efficiently making the pet treat. These and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with the general description of the invention given above and the detailed description of the embodiments given below, serve to explain the principles of the present invention.

FIG. 1 is a perspective, front view of an exemplary microwavable plastic pan in accordance with the principles of the present invention;

FIG. 2 is a top plan view of the pan of FIG. 1;

FIG. 3 is perspective bottom view of the pan of FIG. 1;

FIG. 4 is a bottom plan view of the pan of FIG. 1;

FIG. 5 is schematic view showing a pet treat made with the pan of FIG. 1 being given to a pet;

FIG. 6 is a schematic view of the pan of FIG. 1 being used to make the pet treat of FIG. 5; and

FIG. 7 is a perspective view of another exemplary microwavable plastic pan in accordance with the principles of the present invention.

### DETAILED DESCRIPTION OF THE DRAWINGS

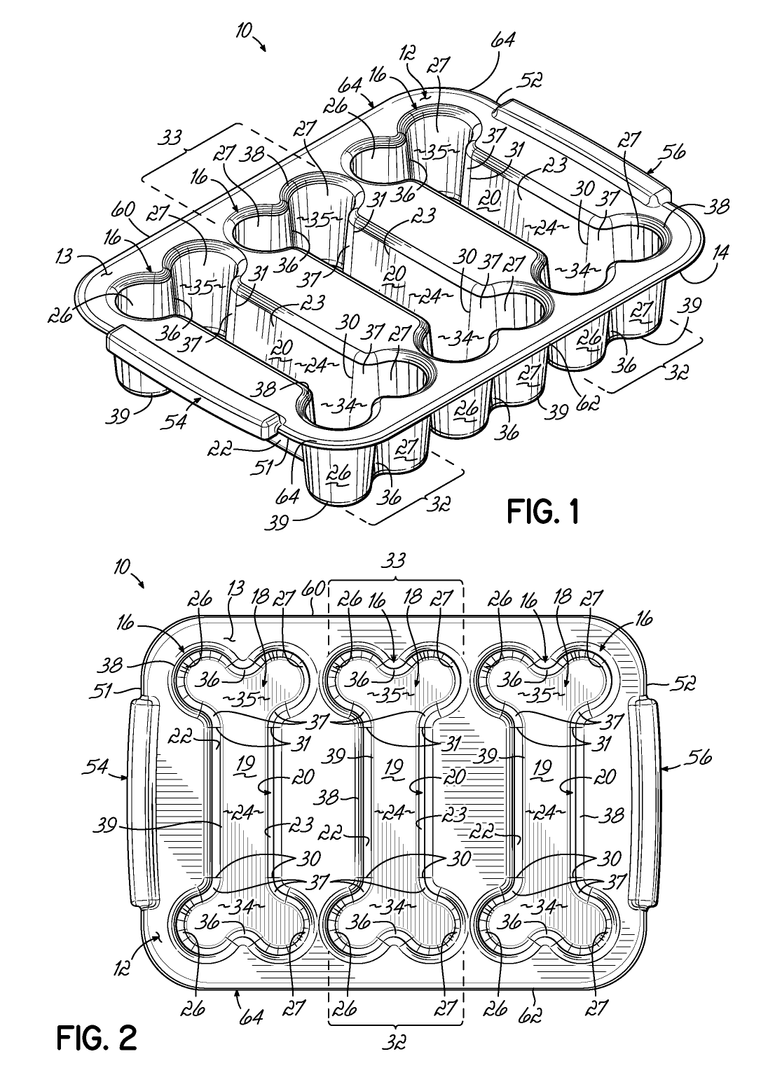

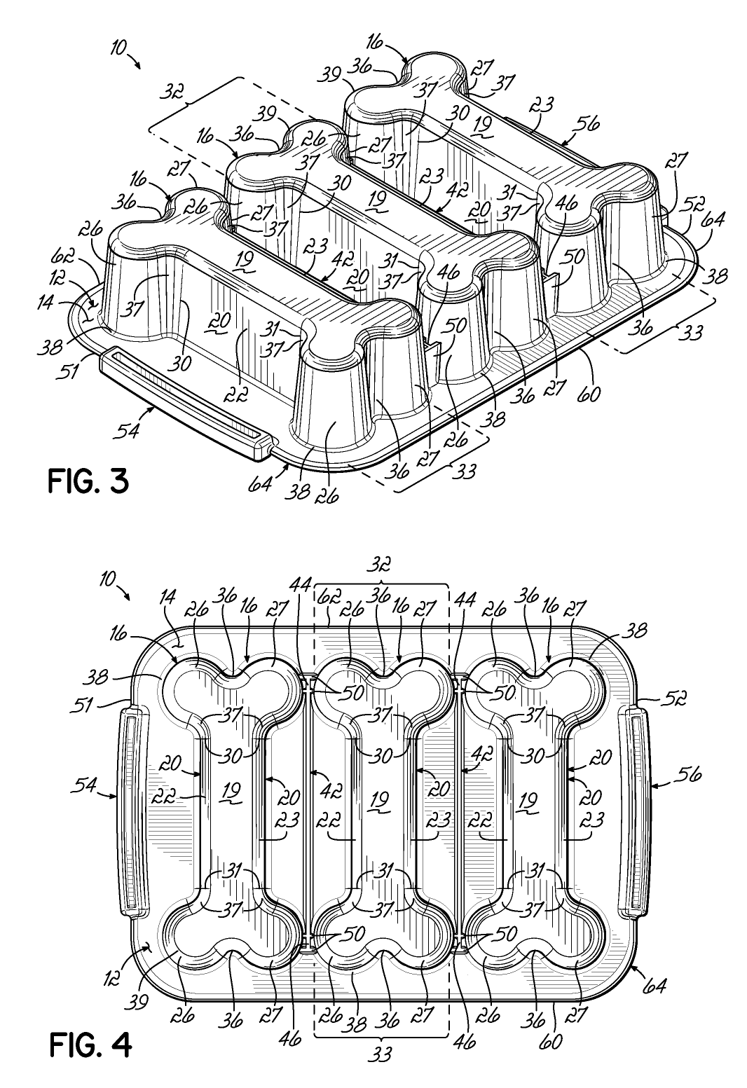

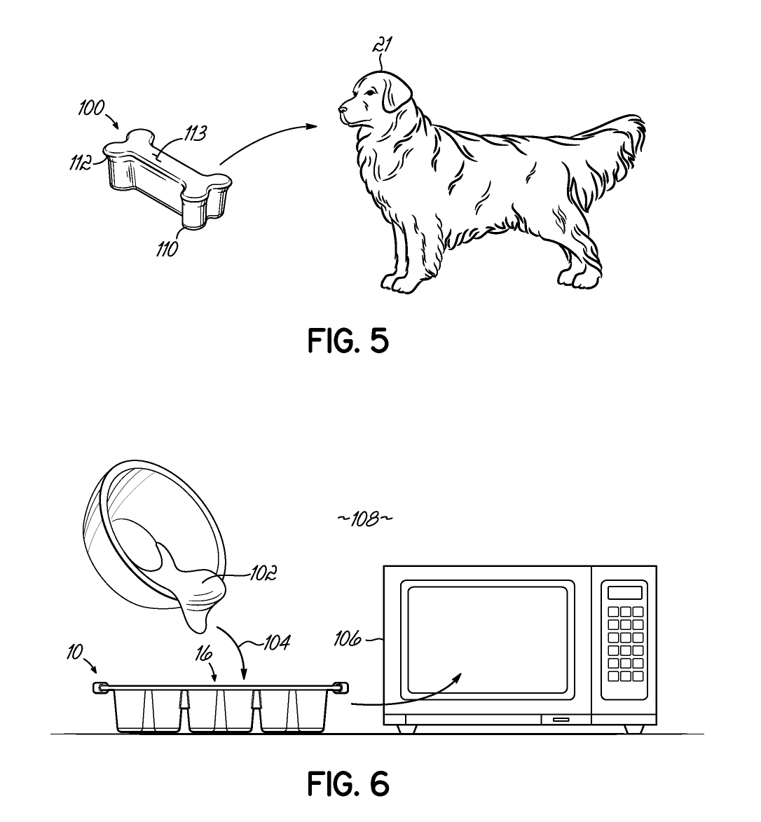

With reference to FIGS. 1-4, there is shown a microwavable plastic pan 10 in accordance with the principles of the present invention. To that end, pan 10 consists essentially of microwavable plastic material having a web 12 defining upper and lower surfaces 13, 14, and one or more pockets 16 (three shown in FIG. 1) formed therein. Each pocket 16 defines a cavity 18 open through the upper surface 13 of web 12 and closed by a solid, bottom wall 19 thereof. Each cavity 18 has a contiguous sidewall 20 defining a shape corresponding to a pet 22 which, in the case of pan 10 of FIG. 1, is a a dog bone, such that each pocket 16 defines a shape corresponding to a type of pet 21 which is a dog (FIG. 5). To that end, contiguous sidewall 20 has parallel central segments 22, 23 defining therebetween a shank portion 24 of cavity 18, and opposite left and right knuckle segments 26, 27 at each end 30, 31 of segments 22, 23, respectively, to define knuckle portions 32, 33 at each end 34, 35 of cavity 18. Contiguous sidewall 20 is canted so as provide a taper to cavity 18 towards bottom wall 19. Knuckle segments 26, 27 may be arcuate in plan view, joining to each other in each knuckle portion at an inverse arcuate aspect 36 (FIG. 2) which flare outwardly towards bottom wall 19 and to central segments 22, 23 at inverse arcuate aspects 37 which also flare outwardly towards bottom wall 19. The upper edge 38 of contiguous wall 20 is slanted outwardly and merges into web 12, while lower edge 39 of wall 20 is slanted inwardly and merges into bottom wall 19.

A ridge piece 42, integrally formed with web 12, may depend from lower surface 14 between adjacent pockets 16 (two ridge pieces 42 are provided for the three bone pocket pan 10 of FIG. 1), to provide rigidity to pan 10. Each ridge piece 42 may terminate at each end 44, 46 in one or a pair of integral bridge segments 50 which extend transverse to the associated ridge piece 42, and merge into and with lower surface 14 of web 12 and adjacent knuckle segments 26, 27 of contiguous sidewall 20.

Integrally formed along left and right edges 51, 52 of web 12 are a pair of thickened segments or handles 54, 56 which extend along a substantial portion of respective edges 51 and 52, but not necessarily all the way to top and bottom edges 60, 62 of web 12. Handles 54, 56 provide an area for a user (not shown) to grip pan 10 for handling. The exposed portions of edges 50, 52 beyond handles 54 and 56, and edges 60, 62, may be provided with a thickened bead as at 64.

With reference to FIGS. 5 and 6, a pet treat 100 having a shape corresponding to the type of pet 21 to be given the pet treat 100, such as dog, may be made as follows. A pet treat mixture 102, which may be formed by mixing a dry pet treat base which may advantageously be of organic material with water and peanut butter, is viscous enough to be pourable. A portion of pet treat mixture 102 is poured into at least one of pockets 16 of pan 10, as at 104 and, due its viscosity, will tend to conform to the shape of cavity 18 thereof. Alternatively, a spatula or other similar implement (not shown) may be used to press the pet treat mixture portion against the contiguous wall 20 and/or bottom wall 19 of the pocket 16 to conform to the shape thereof. The mixture 102 could also be poured into more or all of the pockets 16 and conformed to the shape thereof.

The pan 10, with the mixture 102 therein, is then placed into a microwave oven 106 (such as may be in a home kitchen 108) and microwaved for a couple of minutes to form the final pet treat 100. Thereafter, the pan 10 is removed from oven 106, and the final pet treat 100 formed in each pocket 16 can be removed. As can be seen, pet treat 100 has a shape conforming to pocket 16, including a rounded lower edge 110 conforming to lower edge 39 of wall 20, and an extending eave portion 112 corresponding to upper edge 38 of wall 20. Final pet treat 100 may be given to the pet 21 in that form, or may be iced or otherwise decorated (not shown) as along top surface 113 thereof. A brief cool down period may be advantageous either before or after removal of the pet treat 100 from the pan 10 prior to giving the pet treat 100 to the pet 22.

The dry pet treat base may be comprised of organic materials organic materials, such as about 39% oat Flour (organic); about 39% rice flour (organic); about 8% ground unsweetened Carob chips; about 7% soy flour (organic); about 2% egg replacer; about 2% wheat germ; about 1% flax seed (organic); about 1% cinnamon; about 0.4% baking soda; and about 0.4% baking powder. The mixture 102 may be formed by mixing [amount] of the dry pet treat base with one-quarter cup of water and one tablespoon of peanut butter. With that mixture 102 used to make the pet treat 100, enough should be poured into a pocket 16 to fill the pocket about ⅔ to ¾ full, and the pan then microwaved in oven 106 for about two minutes and thirty seconds on high. A cool-down period of about three t0 five minutes may be sufficient.

In the embodiment of FIG. 1, the pan has a width between left and right edges 50, 52 of about 6.1 inches, and a length between top and bottom edges 60, 62 of about 4.5 half inches. Each pocket 16 may be about 1.1 inch deep, with knuckle portions 32, 33 being about 1.64 inches wide (about 0.89 inches on center), and shank portions 24 being about 0.75 inches wide. Handles 54, 56 are each about 0.25 inches thick, 0.3 inches wide, and 2.5 inches long.

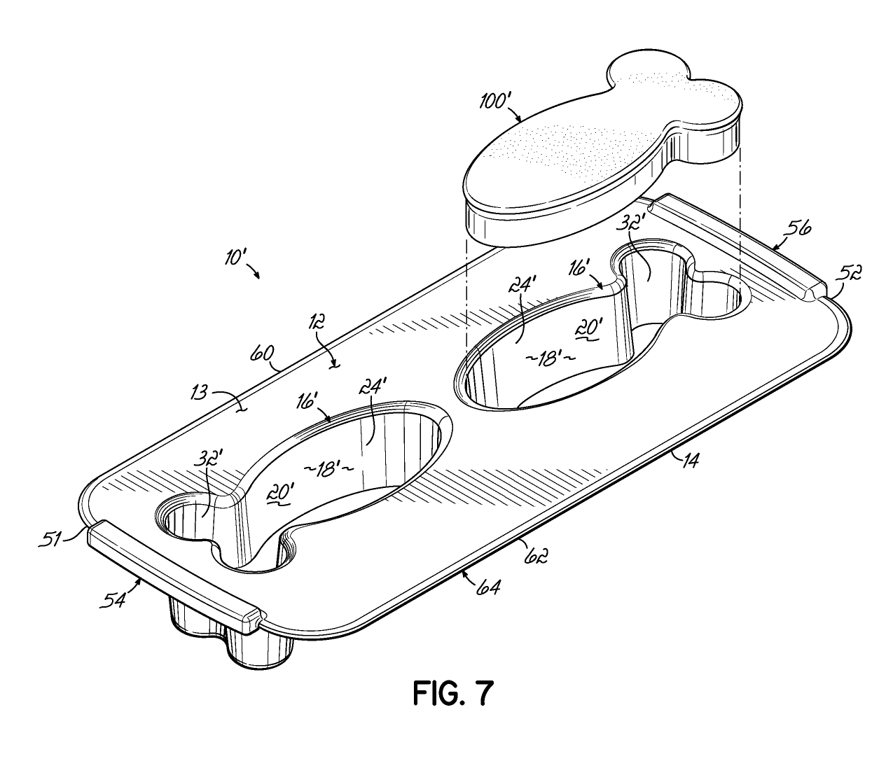

While pockets 16 of pan 10 have a shape corresponding to a type of pet 21 which is a dog, the principles of the present invention may be applied for other types of pets. To that end, and with reference to FIG. 7, a pan 10′ is provided for making pet treats 100′ for a type of pet 21 that is a cat by providing pockets 16′ which are shaped to correspond to a cat such as by taking on the shape of a fish for cavity 18′ thereof. To that end, pan 10′ has a contiguous sidewall 20′ that, instead of defining a cavity 18 shaped like a bone, instead has a cavity 18′ shaped like a fish. Sidewall 20′ thus also has a portion defining a fish body 24′ and fins as at 32′. The pan 10′ is otherwise very much like pan 10 of FIG. 1 (and thus also includes a web 12 with upper and lower surfaces 13, 14, as well as handles 54, 56, by way of example). Pan 10′ is also used to make pet treats 100′ which have a shape corresponding to a cat in the same manner as described above in relation to use of the pan of FIG. 1 for making pet treats 100 having a shape corresponding to a dog.

Advantageously, the microwavable plastic material of pan 10 or 10′ is polypropylene copolymer, such as Pro-fax SG702 available from Basell North America, Inc. or an affiliate thereof, such as LyondellBasell Industries. Alternatively, the microwavable plastic material may be HDPE or silicone. The microwavable plastic material is injection molded into the form of the desired pan as is readily understood by those who work with plastics materials.

While the present invention has been illustrated by the description of embodiments thereof, and while the embodiments have been described in considerable detail, it is not intended to restrict or in any way limit the scope of the appended claims to such detail. Additional advantages and modifications will readily appear to those skilled in the art. For example, while pans 10 and 10′ have been described with bone shaped and fish shaped pockets 16 and 16′ respectively, so that they correspond to a type of pet which is either a dog or a cat, other shapes corresponding to a particular pet type might be used. Similarly, the pan 10 or 10′ can be provided with only one pocket 16 or 16′, or with a plurality of such pockets that are more or less than three in number. In that regard, pan 10′ is shown as having two pockets 16′, although more or fewer could be provided. As will also be readily appreciated, other forms or constructions of pans 10 and 10′ could be utilized. Additionally, while a particular pet treat is described as being made from a mixture comprising dry pet treat base material, water, and peanut butter, other formulations can be used with the pan of the present invention, including mixtures of dry pet treat base material that differs in composition from that described above and with or without peanut butter. The invention in its broader aspects is, therefore, not limited to the specific details, representative apparatus and method, and illustrative examples shown and described. Accordingly, departures may be made from such details without departing from the spirit or scope of the general inventive concept.

Having described the invention, what is claimed is:

1. A method of preparing a pet treat comprising:
mixing materials into a viscous pet treat mixture;
in a home kitchen, placing at least a portion of the viscous pet treat mixture into a pocket of a microwaveable plastic pan, the pocket defining a shape corresponding to a type of pet to be given the pet treat;
placing the plastic pan with the viscous pet treat mixture in the pocket into a microwave oven in the home kitchen;
microwaving the plastic pan with the viscous pet treat in the microwave oven and conforming the mixture to the shape whereby to form a pet treat; and
removing the formed pet treat from the pocket after microwaving before serving the formed pet treat to a pet.

2. The method of claim 1 further comprising obtaining the microwavable plastic pan consisting essentially of microwavable plastic material.

3. The method of claim 1 further comprising obtaining the microwavable pan consisting essentially of microwavable polypropylene copolymer plastic material.

4. The method of claim 1 further comprising obtaining the microwavable plastic pan consisting essentially of microwavable HDPE plastic material.

5. The method of claim 1 wherein the type of pet is a dog, further comprising obtaining the microwavable plastic pan with the pocket defining a shape corresponding to a bone.

6. The method of claim 1 wherein the type of pet is a cat, further comprising obtaining the microwavable plastic pan with the pocket defining a shape corresponding to a fish.

7. The method of claim 1 wherein mixing material into a pet treat mixture includes mixing a dry pet treat base material, water, and peanut butter.

8. The method of claim 1 further comprising serving the removed, formed pet treat to a pet separate from the plastic pan.

9. A method of preparing a pet treat comprising:
mixing materials into a viscous pet treat mixture;
in a home kitchen, placing at least a portion of the viscous pet treat mixture into_each of a plurality of pockets of a microwaveable plastic pan, each pocket defining a shape corresponding to a type of pet to be given the pet treat;
placing the plastic pan with the viscous pet treat mixture in the pockets into a microwave oven in the home kitchen;
microwaving the plastic pan with the viscous pet treat in the microwave oven and conforming the mixture to the shape whereby to form a plurality of pet treats; and
removing the formed pet treats from the pockets after microwaving before serving the formed pet treats to a pet.

10. The method of claim 9 further comprising obtaining the microwavable plastic pan consisting essentially of microwavable plastic material.

11. The method of claim 9 further comprising obtaining the microwavable pan consisting essentially of microwavable polypropylene copolymer plastic material.

12. The method of claim 9 further comprising obtaining the microwavable plastic pan consisting essentially of microwavable HDPE plastic material.

13. The method of claim 9 wherein the type of pet is a dog, further comprising obtaining the microwavable plastic pan with the pockets each defining a shape corresponding to a bone.

14. The method of claim 9 wherein the type of pet is a cat, further comprising obtaining the microwavable plastic pan with the pockets each defining a shape corresponding to a fish.

15. The method of claim 9 wherein mixing material into a pet treat mixture includes mixing a dry pet treat base material, water, and peanut butter.

16. The method of claim 9 further comprising serving the removed, formed pet treats to a pet separate from the plastic pan.
